(19) United States
(12) Patent Application Publication
(10) Pub. No.: US 2009/0211607 A1
(43) Pub. Date: Aug. 27, 2009

(54) Compact system and method for cleaning a window or another smooth surface

(76) Inventor: Karry Lee Garland, Bean Station, TN (US)

Correspondence Address: MICHAEL E. McKEE;Attorney at Law, 804 Swaps Lane, Knoxville, TN, 37923, US

(21) Appl. No.: 12/072,202

(22) Filed: Feb. 25, 2008

(51) Int. Cl. A47L 7/00; A47L 1/00; A47L 1/08; B08B 5/04

(52) U.S. Cl. 134/21; 15/321

(57) ABSTRACT

A cleaning system and method for cleaning window glass or another smooth surface utilizes a first reservoir, a second reservoir, a first battery-operated pump for delivering liquid medium from the first reservoir onto the surface to be cleaned and a second battery-operated pump for drawing spent liquid medium from the surface for transport to the second reservoir. A hand-held wand includes a head having a first face through which the liquid medium is dispensed onto the surface and a second face through which spent liquid medium is drawn from the surface. In addition, a switch is mounted on the wand which permits the user to selectively dispense the liquid medium through the wand or draw the spent liquid medium from the surface, and the reservoirs and pumps are mounted upon a backpack frame enabling these components of the system to be carried upon the back of a user.

### BACKGROUND OF THE INVENTION

This invention relates generally to means and methods for cleaning windows or other smooth surfaces and relates, more particularly, to cleaning systems and methods which involve the dispensing of a liquid medium, such as a cleaning solution, onto a surface to be cleaned.

It is known that the cleaning of a window (or another smooth surface) can be enhanced by the dispensing of a liquid medium, such as a cleaning solution, onto the window and scrubbed with the liquid medium. It is also known that following such a scrubbing operation, the spent liquid medium can be removed from the window to improve the cleaning results further. It would be desirable to provide a system which possesses the capacity to dispense a liquid medium onto the surface to be cleaned and subsequently collect the spent liquid medium from the surface.

Accordingly, it is an object of the present invention to provide a new and improved cleaning system for dispensing a liquid medium onto a surface to be cleaned and for collecting the spent liquid medium from the surface upon completion of a surface-cleaning operation and method of using the system.

Another object of the present invention is to provide such a system which is relatively compact is size for ease of transport by a user.

Still another object of the present invention is to provide such a system having principle operating components which can be carried upon the back of a user during use.

Yet another object of the present invention is to provide such a system wherein liquid medium to be dispensed onto a surface to be cleaned and the spent liquid medium which is collected from the surface is conducted to or from the surface through a single hand-held wand.

A further object of the present invention is to provide such a system whose electrical components are battery-powered.

A still further object of the present invention is to provide such a system which is uncomplicated in structure, yet effective in operation.

### SUMMARY OF THE INVENTION

This invention resides in a cleaning system and method useful for cleaning window glass or another smooth surface.

The system includes a first reservoir for containing a liquid medium for cleaning a surface and a second reservoir for holding spent liquid medium collected from the surface being cleaned. A first conduit network is joined in flow communication to the first reservoir through which the liquid medium is dispensed from the first reservoir onto a surface to be cleaned, and a second conduit network is joined in flow communication with the second reservoir through which the spent liquid medium is conducted to the second reservoir for collection. In addition, means are connected to the first conduit network and to the second conduit network for dispensing the liquid medium from the first reservoir onto the surface to be cleaned and for drawing the spent liquid medium from the surface for delivery to the second reservoir. The system further includes a wand which is adapted to be held by a hand of a user and which has a head portion provided with a first face through which the liquid medium is dispensed onto the surface to be cleaned and a second face through which the spent liquid medium is drawn from the surface. Furthermore, the system includes control means including at least one switch associated with the wand to permit the user to selectively initiate the dispensing of the liquid medium through the first face of the wand head portion onto the surface to be cleaned or the drawing of the spent liquid medium from the surface.

The method of the invention includes the steps involved in using the system of the invention. More specifically, such steps include the positioning the first face of the wand adjacent the surface to be cleaned and the dispensing of an amount of the liquid medium from the first reservoir through the first face onto the surface to be cleaned. Then, the second face of the wand is positioned adjacent the surface, and the spent liquid medium is drawn from the surface and conducted to the second reservoir for collection.

### BRIEF DESCRIPTION OF THE DRAWINGS

FIG. 1 is a perspective view of an embodiment of the system of the present invention shown being utilized for cleaning a window.

FIG. 2 is an alternative view of the backpack assembly and hand-held wand of the FIG. 1 system.

FIG. 3 is a view of the wand of the FIG. 1 assembly taken along line 3-3 of FIG. 2.

FIG. 4 is a perspective view depicting the use of the wand of the FIG. 1 system when withdrawing spent liquid medium from the surface being cleaned.

### DETAILED DESCRIPTION OF AN ILLUSTRATIVE EMBODIMENT

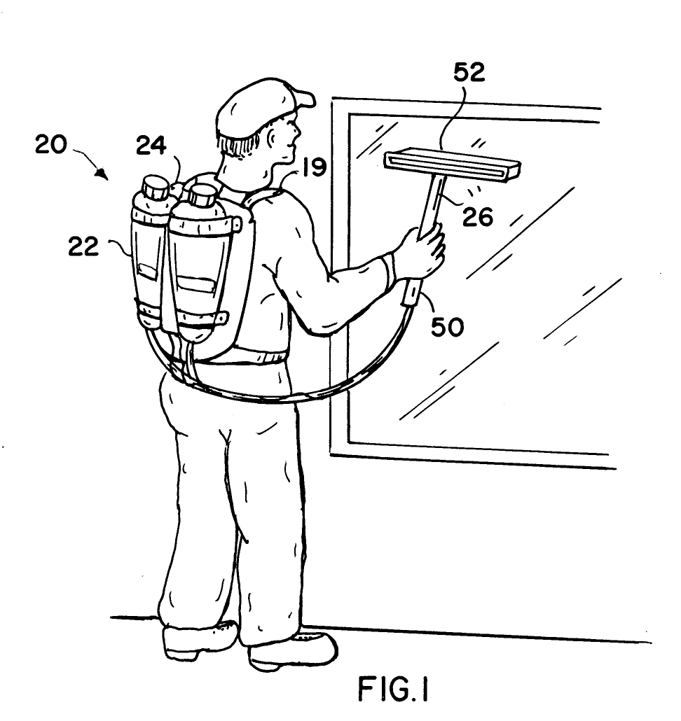

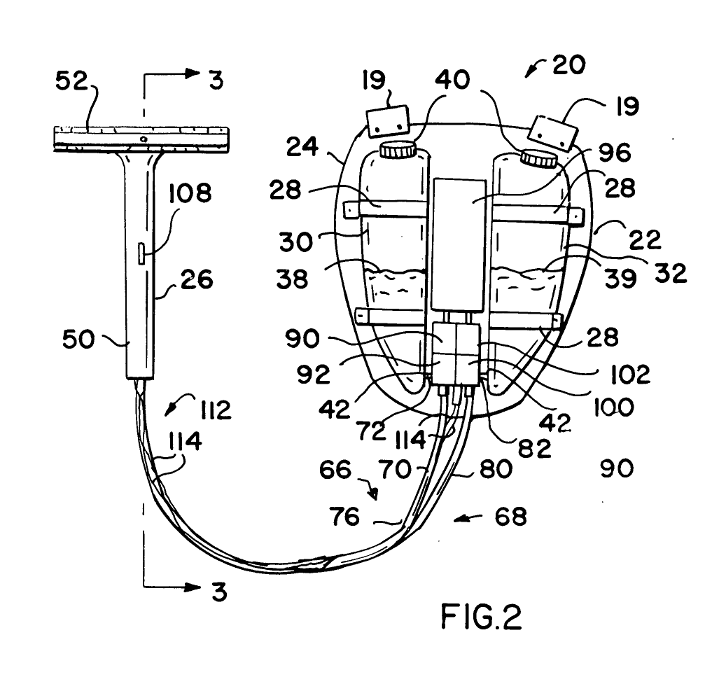

Turning now to the drawings in greater detail and considering first FIGS. 1 and 2, there is illustrated an embodiment, generally indicated 20, of a cleaning system within which features of the present invention are embodied. The system 20 includes a backpack assembly 22 having a backpack frame 24 which is adapted to be supported upon the back of a user and a wand 26 which is adapted to be held by the hand of the user during use of the system 20. The backpack assembly 22 includes a plurality of system components, described herein, which are supported in a relatively compact arrangement upon the frame 24, and the wand 26 is connected to the components of the backpack assembly 22 so that liquid medium (unused and spent) are conducted between the backpack assembly 22 and the wand 26 during use of the system 20.

The backpack frame 24 is constructed of a relatively hard plastic material which is preferably shaped, or molded, to fit comfortably upon the back of a user when worn and is accompanied by a pair of loop-defining shoulder straps 19 which are joined between the top and side edges of the base 18 in a manner enabling the base 18 to be carried upon the user's back during use of the system 20.

As best shown in FIG. 2, the system components which are fixedly mounted upon the frame 24 of the backpack assembly 22 includes a first reservoir 30, a second reservoir 32 and a pump/vacuum assembly, generally indicated 34, positioned between the reservoirs 30, 32. As will be apparent herein, the first reservoir 30 is adapted to hold a liquid medium 38 which can be dispensed upon a surface to be cleaned, and the second reservoir 32 is adapted to hold spent liquid medium 39 which is collected from the surface being cleaned. In this connection, each reservoir 30 or 32 is somewhat kidney-shaped in form, is connected to the backpack frame 22 with fasteners (not shown) and straps 28, and is provided with an access opening at the top thereof which is provided with a removable cap 40. Each reservoir 30 or 32 includes a second access port 42 adjacent the bottom thereof through which liquid medium is dispensed from or conducted to the reservoir 30 or 32. Each reservoir 30 or 32 can be constructed of plastic, but other materials can be used. Furthermore and to enhance the compactness (and thereby reduce the bulkiness) of the reservoirs 30, 32, it is preferred that neither reservoir 30 or 32 possess more than about a two gallon capacity.

The liquid medium 38 which can be held within the reservoir 30 can be water or some other fluid, such as a soap and water mixture or a commercially-prepared solution (such as that available under the trade designation Windex), suitable for cleaning the surface desired to be cleaned.

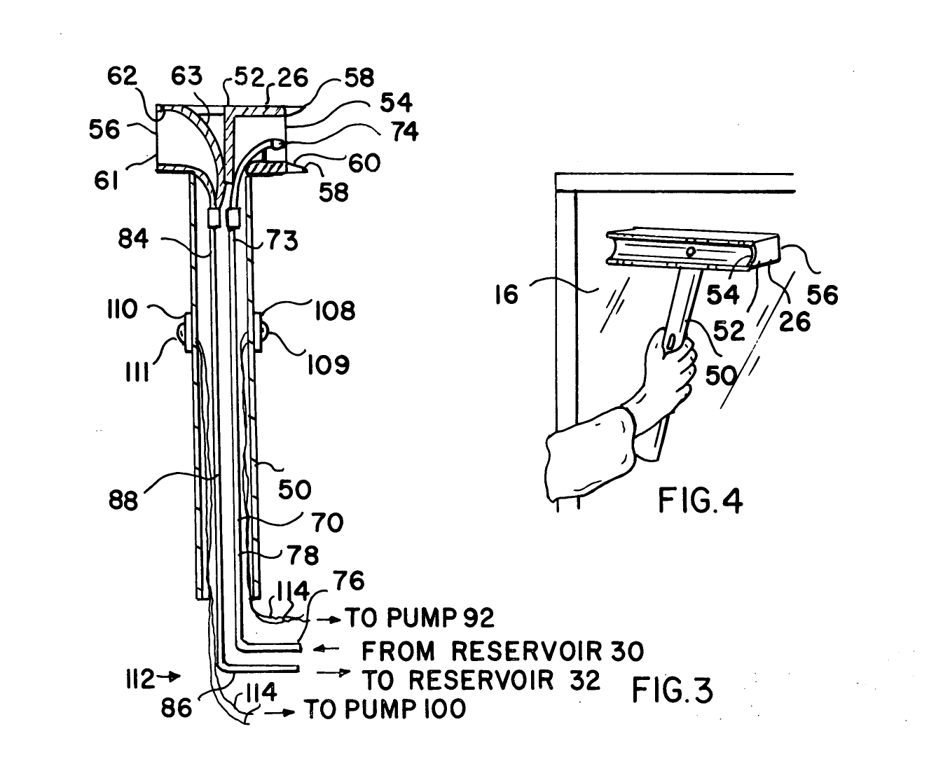

With reference to FIGS. 2 and 3, the wand 26 of the depicted system 20 includes a hollow handle portion 50 which is elongated in shape and adapted to be gripped by the hand of a user during use of the system 20 and further includes an elongated head portion 52 which is securely attached to one end of the handle portion 50 at a location situated about midway along the length of the head portion 52.

The handle portion 50 is provided with two working faces, indicated 54 and 56, which are situated on opposite sides of the head portion 52. One face 54 includes a pair of elongated squeegee members 58 which are arranged in a spaced, parallel relationship along the length of the face 54. The face 54 further defines a central opening 60 which is disposed between the squeegee members 58 and which is in communication with the hollow interior of the handle portion 50 of the wand 26. As will be apparent herein, the liquid medium which is dispensed from the first reservoir 30 for dispensing upon a surface to be cleaned is routed through the handle portion 50 and out of the face 54 of the wand 26 through the opening 60 thereof.

Meanwhile, the other face 56 of the wand 26 defines a central opening 62 which is bounded by forward edges 61 which lie within a common plane. The opening 62 is in flow communication with the hollow interior of the handle portion 50 of the wand 26 by way of a funnel-shaped section 63 mounted in the head portion 52 of the wand 26 so the smaller end of the funnel-shaped section 63 is disposed adjacent the handle portion 50. As will be apparent herein, the liquid cleaning medium which is dispensed onto a surface being cleaned can be subsequently drawn back into the wand 26 through the opening 62 therein for transfer to the second reservoir 32 for collection.

With reference still to FIG. 2, there is connected between the backpack assembly 22 and the wand 26 a first conduit network 66 and a second conduit network 68 through which the liquid cleaning medium (either unused or spent) is conducted between the backpack assembly 22 and the wand 26. In this connection, the first conduit network 66 is joined in flow communication to the first reservoir 30 through which the cleaning liquid is dispensed from the first reservoir 30 onto a surface to be cleaned, and the second conduit network 68 is joined in flow communication with the second reservoir 32 through which spent cleaning liquid is conducted to the second reservoir 32 for collection.

With reference to FIGS. 2 and 3, the first conduit network 66 includes a flexible conduit 70 having one end 72 which is sealingly joined to the access port 42 of the first reservoir 30 adjacent the lower end thereof (by way of a delivery pump described herein) and another end 73 which is supported within the head portion 52 of the wand 26 and sealingly joined to at least one spray nozzle 74 fixedly supported within the head portion 52 so that liquid cleaning medium which is dispensed therefrom is directed out of face 54 thereof through the central opening 62 defined between the squeegee members 58. Instead of a single nozzle 74, the wand 26 can include a manifold (not shown) to which a plurality of nozzles, like the nozzle 74, are attached, and the wand-end 73 of the conduit 70 can be sealingly joined to the nozzle-bearing manifold. The conduit 70 further includes a lengthy section 76 which extends between the first reservoir 30 and the wand 62 and a shorter section 78 which extends through the handle portion 50 of the wand 26 to the nozzle 74.

By comparison, the second conduit network 68 includes a flexible conduit 80 having one end 82 which is joined to the access port 42 of the second reservoir 32 (by way of a vacuum pump described therein) so that spent liquid cleaning medium collected from the surface being cleaned and transported through the conduit 80 is dispensed into the second reservoir 32 for collection. The conduit 80 has another end 84 which is sealingly connected to the small end of the funnel-shaped section 63 mounted within the head portion 52 of the wand 26 so that the conduit 80 is connected in flow communication with the opening 62 provided in the face 56 of the wand 26. Connected between the opening 62 and the second reservoir 32 in such a manner, the conduit 80 enables the transfer of the (spent) liquid cleaning medium which is drawn from the surface being cleaned to the second reservoir 32. The conduit 80 includes a lengthy section 86 which extends between the second reservoir 32 and the wand 26 and a shorter section 88 which extends through the handle portion 52 of the wand 26 to the funnel-shaped section 63.

With reference again to FIG. 2, the system 20 also includes means, generally indicated 90, which are connected to the first conduit network 66 and the second conduit network 68 for pumping liquid medium from the first reservoir 30 onto the surface to be cleaned and for drawing the spent liquid cleaning medium from the surface being cleaned for delivery to the second reservoir 32. Within the depicted system 20, such means 90 includes a first, or delivery, pump 92 (introduced earlier) which is mounted within the backpack assembly 22 of system components and connected in-line with the conduit 70 of the first conduit network 66 adjacent the bottom of the reservoir 30. In use, the pump 92 operates to pump liquid cleaning medium from the first reservoir 30 and out the face 54 of the wand head portion 52 through the spray nozzle 74 thereof, preferably in a pressurized condition. For powering the pump 92, the system 20 includes a battery-operated motor 94 mounted adjacent and operatively connected to the pump 92, and for powering the motor 94, the system 20 includes a rechargeable battery pack 96 which is mounted between the reservoirs 30 and 32 and operatively wired to the motor 94 for supplying power thereto.

The means 90 also includes a second, or vacuum, pump 100 which is mounted within the backpack assembly 22 of system components and connected in-line with the conduit 80 of the second conduit network 68 adjacent the bottom of the reservoir 32. In use, the pump 100 operates to create a below-atmospheric pressure (e.g. vacuum) condition within the central opening 62 of the face 56 of the wand 26 so that as the wand 25 is moved across a surface being cleaned as the edges 61 of the face 56 are positioned against the surface, liquid cleaning medium which has been previously dispensed thereon is drawn, or vacuumed, into the conduit 80 through the opening 62. For powering the pump 100, the system 20 includes a battery-operated motor 102 mounted adjacent and operatively connected to the pump 100, and the battery pack 96 (introduced earlier) is operatively wired to the motor 102 for providing power thereto.

With reference again to FIG. 3 and for controlling the operation of the pump 92 (and thus the dispensing of the liquid cleaning medium through the nozzle 74) and the operation of the pump 100 (and thus the drawing, or vacuuming, of spent liquid cleaning medium from the surface being cleaned, the system 20 includes a pair of switch mechanisms 108 and 110, respectively, mounted within the handle portion 50 of the wand 26 and which are accessible to the user who holds the wand 26 in his hand by the handle portion 50 of the wand 26. Although the switch mechanisms 108 and 110 could be embodied within a single switch, the mechanism 108 of the depicted embodiment 20 includes a depressible switch 109 mounted on one side of the handle portion 50 and wired in-line with the motor 94 associated with the pump 92, and the mechanism 110 includes a depressible switch 111 mounted on the opposite side of the handle portion 50 and wired in-line with the motor 102 associated with the pump 100.

Mounted within the wand handle portion 50 in such a manner, the switch 109 can be operated with the index finger of the user as the user holds the wand 26 in his hand by the handle portion 50 for dispensing the liquid cleaning medium onto a surface to be cleaned. Similarly, the switch 111 can be operated with the index finger of a user as the user holds the wand 26 in his hand by the handle portion 50 for drawing spent liquid cleaning medium from the surface being cleaned. It will be understood that a network, indicated 112 in FIGS. 2 and 3, of electrical wires 114 (which are joined between switch mechanisms 108, 110 and the motors 94, 102) extend along the lengthy sections 76, 86 of the first and second conduits 70 and 80 as the wires 114 are routed between the backpack assembly 22 of system components and the wand 26. Furthermore, each of the wires 114, along with the conduits 70 and 80 enter the wand 26 through the end of the handle portion 50 opposite the head end.

Prior to use of the system 20, it is preferable that the first reservoir 30 contain (or be filled with) an amount of unused liquid cleaning medium and the second reservoir 32 be substantially empty. After all, during use of the system 20, it will be the unused liquid cleaning medium which is dispensed from the wand 26, and the spent liquid cleaning medium is subsequently drawn through the wand 26 for collection within the second reservoir 32.

To use the system 20 and with reference again to FIG. 1, the user inserts his arms through the loop-defining straps 19 associated with the backpack frame 24 to thereby mount the backpack assembly 22 upon his back and, while grasping the wand 26 by the handle portion 50 thereof, the user places the face 54 of the wand head portion 52 adjacent the surface, such as the glass surface 16 of a window to be cleaned. With the user's hand gripped about the handle portion 50 in the manner depicted in FIG. 1, the index finger of the grasping hand depresses the switch 109 to thereby initiate the operation of the delivery pump 92. Once operating, the pump 92 transports unused liquid cleaning medium from the first reservoir 30 onto the surface 16 through the nozzle 74.

As the liquid cleaning medium is dispensed, or sprayed, onto the surface 16, the user can move the wand 26 in back and forth or up and down motions to spread the dispensed liquid across the surface 16 as the squeegee members 58 move in sliding relationship across the surface 16. It follows that by moving the wand 26 across the surface 16 in such a manner, the squeegee members 58 both spread the liquid cleaning medium across the surface 16 and scrub the surface 16 with the liquid cleaning medium. It also follows that the user can control the quantity of liquid cleaning medium dispensed through the nozzle 74 by controlling the amount of time that he maintains the switch 109 in a depressed condition. In other words, as long as the switch 109 is depressed by the user's index finger, the liquid cleaning medium will be dispensed through the nozzle 74. Then, to shut off the flow of cleaning fluid through the nozzle 74, the user's finger is removed from the switch 109 to permit the switch 109 to return to an undepressed condition.

When it is desired to cease cleaning the surface 16 with the face 54 of the wand head portion 52 and instead remove the spent liquid cleaning medium (which is likely to contain entrained dirt or grime scrubbed from the surface 16), the switch 109 is permitted to return to its undepressed condition (so that the delivery of cleaning liquid through the nozzle 74 is shut off) and the wand 26 is turned over (to the position illustrated in FIG. 4) so that the working face 56, rather than the working face 54, is positioned against the surface 16. With the edges 61 of the wand face 56 positioned in abutting relationship with the surface 16 and the user's hand grasped about the wand hand portion 50, the switch 111 is depressed with the user's index finger to initiate operation of the vacuum pump 100 so that a below-atmospheric pressure, or vacuum, condition is created in the opening 62 of the wand face 56. The vacuum condition which is created in the wand face opening 62 by the vacuum pump 100 draws the spent liquid cleaning medium disposed in the vicinity of the face 56 into the wand head portion 52 through the opening 62 thereof and transports the vacuumed liquid cleaning medium to the second reservoir 32 for collection.

Preferably, the wand 26 is moved across the surface 16 with back and forth or up and down motions (as one would vacuum a carpet) to enhance the collection of the spent liquid medium from the surface 16. Again, the user can control the duration of vacuum-removal of the spent liquid cleaning medium through the head portion 52 of the wand 26 by controlling the amount of time that he maintains the switch 111 in a depressed condition. In other words, as long as the switch 111 is depressed by the user's index finger, the vacuum pump 100 remains ON. To shut off the vacuum through the wand 26, the user's finger is simply removed from the switch 111 to permit the switch 111 to return to an undepressed condition.

When the first reservoir 30 becomes depleted of its quantity of liquid cleaning medium, the cleaning operation can be temporarily interrupted to refill the reservoir 30 of unused liquid cleaning medium. Similarly, when the second reservoir 32 becomes filled with spent liquid cleaning medium collected by the vacuum pump 100, the cleaning operation can be temporarily interrupted to empty the reservoir 32 of its collected contents. It follows that during a cleaning operation involving both the dispensing of liquid cleaning medium onto a surface 16 to be cleaned and the vacuuming of spent liquid cleaning medium from the surface 16 ensures that the weight of the backpack assembly 22 will remain substantially constant, and the system 20 is further advantageous in this respect.

It follows from the forgoing that a system 20 and method for cleaning a window or another smooth surface has been described. The delivery pump 92 and the first conduit network 66 is employed to deliver cleaning liquid from the first reservoir 30 to a surface to be cleaned, and the vacuum pump 100 and the second conduit network 66 is employed to remove spent liquid cleaning medium from the surface being cleaned for collection. Moreover, many of the principle components of the system 20 are mounted upon the frame 24 of the backpack assembly 22 of system components for ease of portability, and the operation of the motors 94, 102 for the pumps 92, 100 off of a rechargeable battery pack 96 obviates the need to deal with any bulky extension cords. Furthermore, the switches 109 and 111 mounted on the wand 26 enable the delivery or vacuum operations of the system 20 to be readily switched ON or OFF by a user.

It will be understood that numerous modifications and substitutions can be had to the aforedescribed embodiment without departing from the spirit of the invention. For example, although the aforedescribed embodiment 20 has been shown and described as including a wand 26 whose handle portion 52 is relatively short, an extension member (not shown) can be attached to the handle portion 52 to increase the useful reach of the wand 26 by the user. In such an instance, such an extension member would preferably be interposed between the switches 109 and 111 and the head portion 52 to maintain the user's access to the switches 109 and 111 remotely of the head portion 50. Accordingly, the aforedescribed embodiment is intended for the purpose of illustration and not as limitation.

1. A cleaning system useful for cleaning window glass or another smooth surface, said system comprising:
a first reservoir for containing a liquid medium for cleaning a surface;
a second reservoir for holding spent liquid medium collected from the surface being cleaned;
a first conduit network joined in flow communication to the first reservoir through which the liquid medium is dispensed from the first reservoir onto a surface to be cleaned;
a second conduit network joined in flow communication with the second reservoir through which the spent liquid medium is conducted to the second reservoir for collection;
means connected to the first conduit network and to the second conduit network for dispensing the liquid medium from the first reservoir onto the surface to be cleaned and for drawing the spent liquid medium from the surface for delivery to the second reservoir;
a wand adapted to be held by a hand of a user and having a head portion provided with a first face through which the liquid medium is dispensed onto the surface to be cleaned and a second face through which the spent liquid medium is drawn from the surface; and
control means including at least one switch associated with the wand to permit the user to selectively initiate the dispensing of the liquid medium through the first face of the wand head portion onto the surface to be cleaned or the drawing of the spent liquid medium from the surface.

2. The system as defined in claim 1 further comprising means for supporting the first reservoir, the second reservoir, and the means for dispensing and for drawing upon the back of the user.

3. The system as defined in claim 2 wherein the means for supporting includes a backpack frame upon which the first reservoir, the second reservoir and the means for dispensing and drawing are mounted, and the backpack frame is adapted to be carried upon the back of the user.

4. The system as defined in claim 1 wherein the means for dispensing and for drawing includes at least one pump connected in line with one of the first or second conduit networks for effecting the flow of liquid medium between one of the first and second reservoirs and the wand.

5. The system as defined in claim 4 wherein the at least one pump is battery-operated, and the system further includes a battery for supplying the power to operate the at least one pump.

6. The system as defined in claim 1 wherein the means for dispensing and for drawing includes a first battery-powered pump for effecting the flow of the liquid medium from the first reservoir to the wand and a second battery-powered pump for effecting the flow of the spent liquid medium from the wand to the second reservoir.

7. The system as defined in claim 1 wherein each of the first and second reservoirs has a capacity of about two gallons.

8. The system as defined in claim 1 wherein the wand has a handle portion which is adapted to be grasped by a user, and the at least one switch of the control means is mounted upon the handle portion of the wand enabling the user to operate the at least one switch while the handle portion is grasped by the user.

9. The system as defined in claim 1 wherein the wand includes at least one squeegee member associated with the first face of the wand and with which the surface being cleaned can be scrubbed with the liquid medium which has been dispensed onto the surface.

10. The system as defined in claim 1 wherein the first and second faces of the wand are on opposite sides of the wand head portion.

11. A cleaning system for cleaning window glass or another smooth surface with a liquid medium, said system comprising:
a first reservoir for containing a liquid medium for cleaning a surface;
a second reservoir for holding spent liquid medium collected from the surface being cleaned;
a first conduit network joined in flow communication to the first reservoir through which the liquid medium is conducted from the first reservoir and dispensed onto the surface to be cleaned;
a second conduit network joined in flow communication with the second reservoir through which the spent liquid medium is conducted from the surface to the second reservoir for collection;
a battery-operated delivery pump connected in-line with the first conduit network for pumping the liquid medium from the first reservoir to the surface to be cleaned;
a battery-operated vacuum pump connected in-line with the second conduit network for effecting the draw of the spent liquid medium from the surface and the transport of the spent liquid medium to the second reservoir;
a wand adapted to be held by a hand of a user and having a head portion provided with a first face through which the liquid medium is dispensed from the first reservoir onto the surface to be cleaned and a second face through which the spent liquid medium is drawn from the surface;
control means including at least one switch associated with the wand to permit the user to control the operation of the delivery pump for dispensing the liquid medium through the first face of the wand head portion onto the surface to be cleaned or to control the operation of the vacuum pump for drawing the spent liquid medium from the surface; and
a backpack frame upon which the first reservoir, the second reservoir, the delivery pump, and the vacuum pump are mounted so that the reservoirs and pumps can be carried upon the back of a user during a cleaning operation performed with the system.

12. The system as defined in claim 11 wherein the wand includes a nozzle connected in flow communication with the first conduit means so that the liquid medium which is transported to the wand from the first reservoir is dispensed onto the surface to be cleaned through the nozzle.

13. The system as defined in claim 11 wherein the wand includes at least one squeegee member associated with the first face of the wand and with which the surface being cleaned can be scrubbed with the liquid medium which has been dispensed onto the surface.

14. The system as defined in claim 11 wherein the first and second faces of the wand are disposed on opposite sides of the wand head portion.

15. The system as defined in claim 11 wherein the at least one switch is a first switch enabling the user to control the operation of the delivery pump and the control means includes a second switch associated with the wand enabling the user to control the operation of the vacuum pump.

16. The system as defined in claim 15 wherein the first and second faces of the wand are disposed on opposite sides of the wand head portion, the wand includes a handle portion which is attached to the head portion and the first and second switches are mounted on opposite sides of the wand handle portion at positions thereon so that depending upon which face of the wand is operatively positioned adjacent the surface to be cleaned, the first or second switch can be actuated by the user for controlling the operation of the corresponding delivery pump or the vacuum pump.

17. A method for cleaning window glass or another smooth surface, said method comprising the steps of:
providing a system comprising:
a) a first reservoir for containing a liquid medium for cleaning a surface;
b) a second reservoir for holding spent liquid medium drawn from the surface being cleaned;
c) a first conduit network joined in flow communication to the first reservoir through which liquid medium is dispensed from the first reservoir onto a surface to be cleaned;
d) a second conduit network joined in flow communication with the second reservoir through which spent liquid medium is conducted to the second reservoir for collection;
e) means connected to the first conduit network and to the second conduit network for dispensing liquid medium from the first reservoir onto the surface to be cleaned and for drawing spent liquid medium from the surface for delivery to the second reservoir;
f) a wand adapted to be held by a hand of a user and having a head portion provided with a first face through which the liquid medium is dispensed onto the surface to be cleaned and a second face through which the spent liquid medium is drawn from the surface; and
h) control means including at least one switch associated with the wand to permit the user to initiate the dispensing of the liquid medium through the first face of the wand head portion onto the surface to be cleaned or the drawing of spent liquid medium from the surface;
positioning the first face of the wand adjacent the surface to be cleaned;
dispensing an amount of the liquid medium from the first reservoir through the first face onto the surface to be cleaned;
positioning the second face of the wand adjacent the surface; and
drawing spent liquid medium from the surface and conducting the spent liquid medium to the second reservoir for collection.

18. The method as defined in claim 17 wherein the step of dispensing is immediately followed by a step of scrubbing the surface to be cleaned with the dispensed liquid medium.
